(19) United States
(12) Patent Application Publication
(10) Pub. No.: US 2017/0120847 A1
(43) Pub. Date: May 4, 2017

(54) VEHICLE ILLUMINATION APPARATUS

(71) Applicant: HONDA MOTOR CO., LTD., Tokyo (JP)

(72) Inventors: Katsuyasu YAMANE, Utsunomiya-shi (JP); Taichi SOGO, Utsunomiya-shi (JP); Norio TERUI, Utsunomiya-shi (JP); Yuji TSUCHIYA, Utsunomiya-shi (JP); Yasuhiro KONISHI, Kawagoe-shi (JP); Junichi YAMAGUCHI, Wako-shi (JP)

(21) Appl. No.: 15/334,547

(22) Filed: Oct. 26, 2016

(30) Foreign Application Priority Data
Oct. 30, 2015 (JP) 2015-214414

(51) Int. Cl. B60R 16/023; B60Q 3/04; B60Q 3/02

(52) U.S. Cl. CPC B60R 16/0235; B60Q 3/0296; B60Q 3/046

(57) ABSTRACT

A vehicle illumination apparatus includes: a start switch that is provided in a vehicle interior, is operated by a vehicle user, and is used to start a vehicle system; a plurality of light sources arranged on a curved line that extends in a direction or in a plurality of directions from the start switch as an origin; and a control unit that turns on, when receiving a first signal indicating that the start switch is operated from an OFF state to an ON state, the plurality of light sources from the operated start switch as an origin, in the order of a light source close to the origin to a light source far from the origin of the plurality of light sources along the curved line.

### CROSS-REFERENCE TO RELATED APPLICATION

Priority is claimed on Japanese Patent Application No. 2015-214414, filed on Oct. 30, 2015, the contents of which are incorporated herein by reference.

### BACKGROUND

Field of the Invention

The present invention relates to a vehicle illumination apparatus.

Background

In the related art, an automotive illumination apparatus is known that turns on, when receiving a start signal from a vehicle, a plurality of light sources arranged in the vehicle interior sequentially and thereby imparts a visually dramatic effect (for example, refer to Japanese Unexamined Patent Application, First Publication No. 2012-96564).

### SUMMARY

However, in the related art, consideration is not made with respect to a dramatic effect in response to a user's operation. Therefore, there is a case in which a dramatic effect that improves the affinity between the vehicle and the user cannot be achieved.

In view of the foregoing, an object of an aspect of the present invention is to provide a dramatic effect such that the affinity between a vehicle and a user is improved.

(1) An aspect of the present invention is a vehicle illumination apparatus that includes: a start switch that is provided in a vehicle interior, is operated by a vehicle user, and is used to start a vehicle system; a plurality of light sources arranged on a curved line that extends in a direction or in a plurality of directions from the start switch as an origin; and a control unit that turns on, when receiving a first signal indicating that the start switch is operated from an OFF state to an ON state, the plurality of light sources from the operated start switch as an origin, in the order of a light source close to the origin to a light source far from the origin of the plurality of light sources along the curved line. The “curved line” includes a “straight line”.

(2) In the aspect of the above (1), the plurality of light sources may be arranged along a ridged line included in a vehicle member in the vehicle interior.

(3) In the aspect of the above (1) or (2), the plurality of light sources may include light sources arranged on a front vehicle member in the vehicle interior continuously in a vertical direction and light sources arranged on the front vehicle member in the vehicle interior continuously in a horizontal direction, wherein the control unit may turn on the light sources arranged continuously in the vertical direction first and then turn on the light sources arranged continuously in the horizontal direction.

(4) In the aspect of any one of the above (1) to (3), the control unit may turn off, when receiving a second signal indicating that the start switch is operated from an ON state to an OFF state, the lit plurality of light sources in the order of the light source far from the origin to the light source close to the origin of the plurality of light sources along the curved line.

(5) In the aspect of any one of the above (1) to (4), the vehicle illumination apparatus may further include one or more in-vehicle devices provided in the vehicle and each having an illumination part, wherein the control unit may turn on, when the plurality of light sources are sequentially turned on, the illumination part of the one or more in-vehicle devices in accordance with the turn-on of the plurality of light sources.

(6) In the aspect of the above (5), the control unit may turn off, when the plurality of light sources are sequentially turned off, the illumination part of the one or more in-vehicle devices in accordance with the turn-off of the plurality of light sources.

(7) In the aspect of any one of the above (1) to (6), part of the plurality of light sources may be provided on an instrument panel of the vehicle, and the control unit may control a speed at which light sources that are provided on the instrument panel of the plurality of light sources are sequentially turned on to be lower than a speed at which light sources that are not provided on the instrument panel of the plurality of light sources are sequentially turned on.

(8) In the aspect of the above (7), the control unit may control a speed at which the light sources that are provided on the instrument panel of the plurality of light sources are sequentially turned off to be lower than a speed at which the light sources that are not provided on the instrument panel of the plurality of light sources are sequentially turned off.

According to the aspects of the above (1) to (3), the control unit turns on the plurality of light sources, from the operated start switch as an origin, sequentially from a light source close to the origin toward a light source far from the origin, and therefore, it is possible to provide a dramatic effect that can improve the affinity between the vehicle and the user when the light sources are turned on.

According to the aspect of the above (4), the control unit turns off the lit plurality of light sources sequentially from the light source far from the origin toward the light source close to the origin, and therefore, it is possible to provide a dramatic effect that can improve the affinity between the vehicle and the user when the light sources are turned off.

According to the aspect of the above (5), the control unit turns on the illumination part of the one or more in-vehicle devices in accordance with the turn-on of the plurality of light sources, and thereby, it is possible to make the start of the in-vehicle device be recognizable to the user.

According to the aspect of the above (6), the control unit turns off the illumination part of the one or more in-vehicle devices in accordance with the turn-off of the plurality of light sources, and thereby, it is possible to make the stop of the in-vehicle device be recognizable to the user.

According to the aspect of the above (7), the control unit can control the speed at which the light sources that are provided on the instrument panel of the plurality of light sources are sequentially turned on to be lower than the speed at which the light sources that are not provided on the instrument panel of the plurality of light sources are sequentially turned on. As a result, the vehicle illumination apparatus can provide the user with a feeling of actively starting the vehicle.

According to the aspect of the above (8), the control unit can control the speed at which the light sources that are provided on the instrument panel of the plurality of light sources are sequentially turned off to be lower than the speed at which the light sources that are not provided on the instrument panel of the plurality of light sources are sequentially turned off. As a result, the vehicle illumination apparatus can provide the user with a feeling of actively stopping the vehicle.

### BRIEF DESCRIPTION OF THE DRAWINGS

FIG. 1 is a view showing an example of a vehicle interior of a vehicle on which a vehicle illumination apparatus is provided.

FIG. 2 is a view of a rear left door seen from the vehicle interior.

FIG. 3 is a view of a rear right door seen from the vehicle interior.

FIG. 4 is a view for describing a supplementary field of view.

FIG. 5 is a configuration view of the vehicle illumination apparatus when a control unit is focused on.

FIG. 6 is a timing chart showing an example of a temporal change in the states of a start switch and light sources when the light sources are turned on.

FIG. 7 is a view showing an appearance in which the light sources are turned on in the order of arrangement by the control of a light source control unit.

FIG. 8 is a timing chart showing an example of a temporal change in the states of the start switch and the light sources when the light sources are turned off.

FIG. 9 is a view showing an appearance in which the light sources are turned off in the order of arrangement by the control of the light source control unit.

FIG. 10 is a view showing an example of the arrangement of in-vehicle devices provided on the vehicle.

FIG. 11 is a timing chart showing an example of a temporal change in the states of the light sources and the in-vehicle devices.

FIG. 12 is a view showing a turn-on speed of the light sources arranged on an instrument panel and the light sources arranged on a vehicle interior sidewall and a door.

FIG. 13 is a view showing a turn-off speed of the light sources arranged on the instrument panel and the light sources arranged on the vehicle interior sidewall and the door.

FIG. 14 is a timing chart showing an example of a temporal change in the states of the start switch and the light sources of a fourth embodiment.

FIG. 15 is a view showing an appearance in which the luminance of the light sources is changed when the light sources are turned on.

FIG. 16 is a timing chart when the light sources are controlled to a third luminance.

FIG. 17 is a view showing an appearance in which the luminance of the light sources is changed when the light sources are turned off.

### DESCRIPTION OF THE EMBODIMENTS

Hereinafter, embodiments of a vehicle illumination apparatus of the present invention will be described with reference to the drawings. The drawings are described using an XYZ coordinate, if necessary.

### First Embodiment

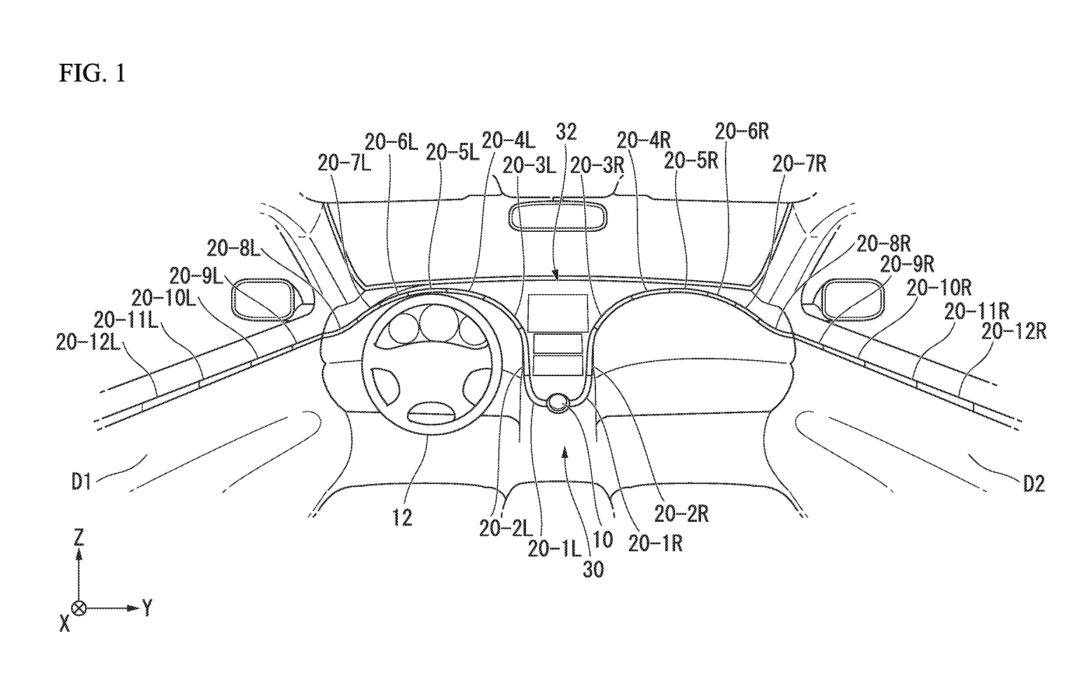

FIG. 1 is a view showing an example of a vehicle interior of a vehicle M on which a vehicle illumination apparatus 1 is provided. An example is described using a vehicle M having a front left door D1, a front right door D2, a rear left door D3, and a rear right door D4. The vehicle illumination apparatus 1 includes, for example, a start switch 10, light sources 20-1R to 20-12R, light sources 20-1L to 20-12L, light sources 22-1L to 22-4L, light sources 22-1R to 22-4R, a storage unit 50, a light source control unit 60, and an ECU (Electronic Control Unit) 70.

The start switch 10 is provided, for example, in the vicinity of an instrument panel 32 or on a center console 30 provided between a passenger seat and a driver seat at which a steering device 12 is arranged. When the start switch 10 is operated by the operation of a user, an in-vehicle device (vehicle system) provided on the vehicle M becomes an ON state. In a case where the start switch 10 and an ignition switch are separately provided, when the start switch 10 is operated, the ignition switch of the vehicle M may become an ON state together with the vehicle system. The start switch 10 may also have a function of the ignition switch. In this case, for example, a first operation of the start switch 10 may be a command of an “ON state” (accessory ON) of an electric component including the vehicle system, and a second operation may be a command of an “ignition ON”. The start switch 10 outputs a signal corresponding to a user's operation.

The start switch 10 may be provided on the front left door D1, the front right door D2, the rear left door D3, the rear right door D4, a ceiling of the vehicle interior, the steering device 12, or the like.

The light sources 20-1R to 20-12R and the light sources 20-1L to 20-12L are arranged on a curved line that extends from the start switch 10 as an origin. The light sources 20-1R to 20-12R are arranged on the instrument panel 32 on the passenger seat side from the center console 30, and on the vehicle interior sidewall of the front right door D2. For example, the light sources 20-1R to 20-8R are arranged along an edge part (ridged line part) at an upper part of the instrument panel 32 on the passenger seat side. For example, the light sources 20-1R to 20-3R are continuously arranged in a vertical direction (Z direction), and the light sources 20-4R to 20-8R are continuously arranged in a horizontal direction (Y direction). For example, the light sources 20-9R to 20-12R are arranged at an upper part of the vehicle interior sidewall of the front right door D2.

The light sources 20-1L to 20-12L are arranged on the instrument panel 32 on the driver seat side of the center console 30, and on the vehicle interior sidewall of the front left door D1. For example, the light sources 20-1L to 20-8L are arranged along an edge part at an upper part of the instrument panel 32 on the driver seat side. For example, the light sources 20-1L to 20-3L are continuously arranged in a vertical direction (Z direction), and the light sources 20-4L to 20-8L are continuously arranged in a horizontal direction (Y direction).

For example, the light sources 20-9L to 20-12L are arranged on the vehicle interior sidewall of the front left door D1.

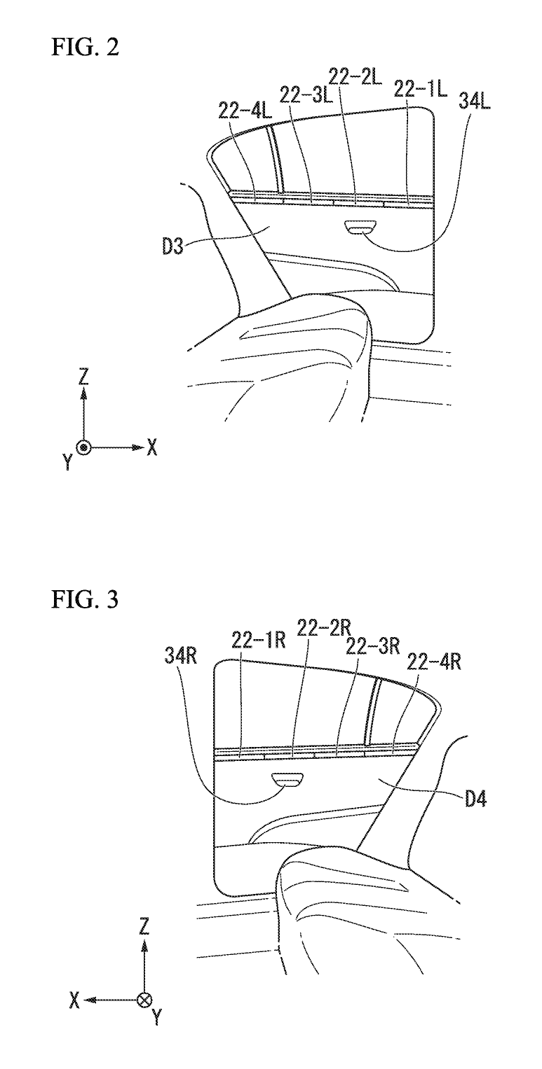

FIG. 2 is a view of the rear left door D3 seen from the vehicle interior. The light sources 22-1L to 22-4L are arranged on a linear line or a curved line at the rear left door D3. The light sources 22-1L to 22-4L are part of the light sources arranged on a curved line that extends from the start switch 10 as an origin. A handle illumination 34L is provided on the rear left door D3. The handle illumination 34L emits light such that the vehicle interior handle is illuminated by the control of the ECU 70.

FIG. 3 is a view of the rear right door D4 seen from the vehicle interior. The light sources 22-1R to 22-4R are arranged on a linear line or a curved line at the rear right door D4. The light sources 22-1R to 22-4R are part of the light sources arranged on a curved line that extends from the start switch 10 as an origin. A handle illumination 34R is provided on the rear right door D4. The handle illumination 34R emits light such that the vehicle interior handle is illuminated by the control of the ECU 70.

Hereinafter, when the light sources 20-1R to 20-12R, the light sources 20-1L to 20-12L, the light sources 22-1L to 22-4L, and the light sources 22-1R to 22-4R are not distinguished, the light sources are simply referred to as a light source 20. When the light source arranged on the driver seat side of the center console 30 and the light source arranged on the passenger seat side of the center console 30 are not distinguished, or when the light source arranged on the rear left door D3 and the light source arranged on the rear right door D4 are not distinguished, the notation “R” or “L” is omitted, and the light sources are simply referred to as light sources 20-1, 20-2, and the like. The case in which the light sources are arranged on a curved line that extends from the start switch 10 as an origin may be a case in which the light sources are arranged at a predetermined interval or a case in which part of the light sources 20 is arranged away from the rest of the light sources 20. For example, there is a pillar part between the doors in the vehicle interior. Even when the light sources 20 provided on the front door and the light sources 20 provided on the rear door are arranged to be separated from each other by the pillar part, these light sources 20 are included in part of the light sources 20 arranged on a curved line that extends from the start switch 10 as an origin.

The number of the light sources 20 is not limited to the above-described number, and the light sources 20-1R to 20-nR or 20-1L to 20-nL may be arranged in the vehicle interior. The number of the light sources 20-1R to 20-nR arranged in the vehicle interior may be different from the number of the light sources 20-1L to 20-nL arranged in the vehicle interior. The arrangement of the light sources 20 is not limited to the example in the drawings and may be an arrangement in which the light sources can be arranged on a curved line that extends from the start switch 10 as an origin. For example, the arrangement in which the light sources can be arranged on a curved line that extends from the start switch 10 as an origin may include the light sources 20 arranged on a straight line or on a curved line that partially branches from the curved line that extends from the start switch 10 as an origin.

The light source 20 may be provided in a light guide body formed of a resin having high transparency such as an acrylic resin. Thereby, the light emitted from the light source 20 is guided efficiently in a predetermined direction according to the internal reflection in the light guide body.

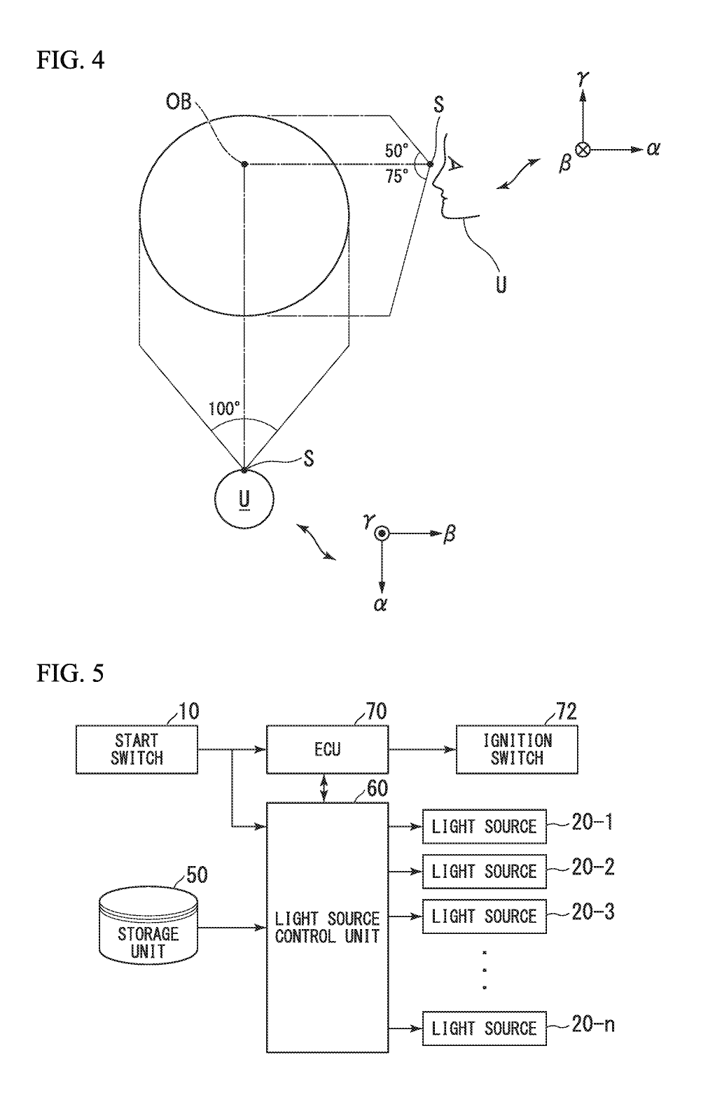

The light source 20 can be preferably arranged in a supplementary field of view when the user sees frontward and when the user moves the head toward a lateral direction (Y direction of FIG. 1 or FIG. 2) in a state where the user is seated on any one of the seats included in the vehicle M. FIG. 4 is a view for describing a supplementary field of view. The supplementary field of view is a range of 50° or less in the upward (+γ) direction, 75° or less in the downward (−γ) direction, and 50° or less in the right and left (β) directions with respect to an angle when an object OB is seen from a reference point S as 0°.

FIG. 5 is a configuration view of the vehicle illumination apparatus 1 when a control unit is focused on. An ignition switch 72 and a variety of in-vehicle devices are provided on the vehicle M. The ECU 70 is formed of, for example, an electronic circuit such as a CPU (Central Processing Unit). The ECU 70 controls the ignition switch 72 to an ON state or an OFF state based on the signal output from the start switch 10. The ECU 70 controls the variety of in-vehicle devices provided on the vehicle M to an ON state or an OFF state. The ignition switch 72 starts or stops an engine based on the control of the ECU 70.

The storage unit 50 is realized by a ROM (Read-Only Memory), a RAM (Random Access Memory), a HDD (Hard Disk Drive), a flash memory, and the like. The storage unit 50 stores a program that is executed by the ECU 70 or the light source control unit 60 and the like.

The light source control unit 60 performs a control by which the light source 20 is turned on or is turned off. The light source control unit 60 turns on, when receiving a signal indicating that the start switch 10 used for starting the vehicle system is operated from an OFF state to an ON state, the plurality of light sources 20 in the order of a light source 20 close to the origin toward a light source 20 far from the origin of the plurality of light sources along the curved line, from the start switch 10 as an origin. The vehicle system is a device provided on the vehicle M such as the storage unit 50, the light source control unit 60, the ECU 70, a variety of in-vehicle devices and the like. Examples of a variety of in-vehicle devices include an air conditioner, a car navigation device, an audio device, and the like. Details of the in-vehicle devices are described later.

The light source control unit 60 turns off, when receiving a signal indicating that the start switch 10 is operated from an ON state to an OFF state, the lit plurality of light sources 20 in the order of the light source 20 far from the start switch 10 to the light source 20 close to the start switch 10.

For example, in a case where the start switch 10 and the ignition switch 72 are separately provided, when the start switch 10 is once operated in an OFF state of the vehicle system, the start switch 10 outputs a signal indicating that the vehicle system is operated to be turned on. When the next prolonged push operation is made, the start switch 10 outputs a signal indicating that the vehicle system is operated to be turned off.

For example, when the start switch 10 also has a function of the ignition switch 72, the start switch 10 may output, in an OFF state of the vehicle system, a signal indicating that “ON” (accessory ON) of the electric component including the vehicle system is commanded at a first operation of the start switch 10 and a signal indicating that “ignition ON” is commanded at a second operation of the start switch 10. In this case, the light source control unit 60 may turn on the plurality of light sources 20 at an “electric component ON” operation or may turn on the plurality of light sources 20 at an “ignition ON” operation. The light source control unit 60 may turn off the plurality of light sources 20 at an “electric component OFF” operation or may turn off the plurality of light sources 20 at an “ignition OFF” operation.

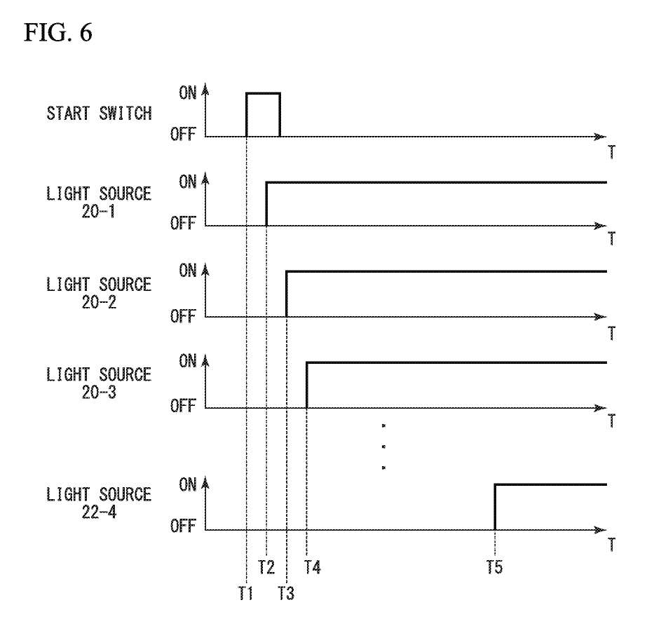

FIG. 6 is a timing chart showing an example of a temporal change in the states of the start switch 10 and the light sources 20 when the light sources are turned on. When the start switch 10 is made to an ON state at a time T1, the light source control unit 60 acquires an ON signal output by the start switch 10. At a time T2, the light source control unit 60 controls the light source 20-1 to be an ON state. Thereby, the light source 20-1 is turned on. At a time T3, the light source control unit 60 controls the light source 20-2 to be an ON state, and at a time T4, the light source control unit 60 controls the light source 20-3 to be an ON state. Then, similarly, the light source control unit 60 controls the light source 20-4 to be an ON state, . . . , and at a time T5, the light source control unit 60 controls the light source 22-4 to be an ON state. Thereby, the plurality of light sources 20 are turned on in the order of the light source 20-1 close to the start switch 10 to the light source 22-4 far from the start switch 10, from the operated start switch 10 as an origin. A speed at which the plurality of light sources 20 are turned on in the order of arrangement may be constant or may be variable. When a predetermined time elapses from when all the light sources 20 are turned on, a control may be performed such that the luminance of the lit light source 20 is changed or the light source 20 is turned off. The start switch 10 may have a light source. In this case, after the light source of the start switch 10 is turned on, a light source 20 that is arranged adjacent to the start switch 10 may be turned on based on the control of the light source control unit 60.

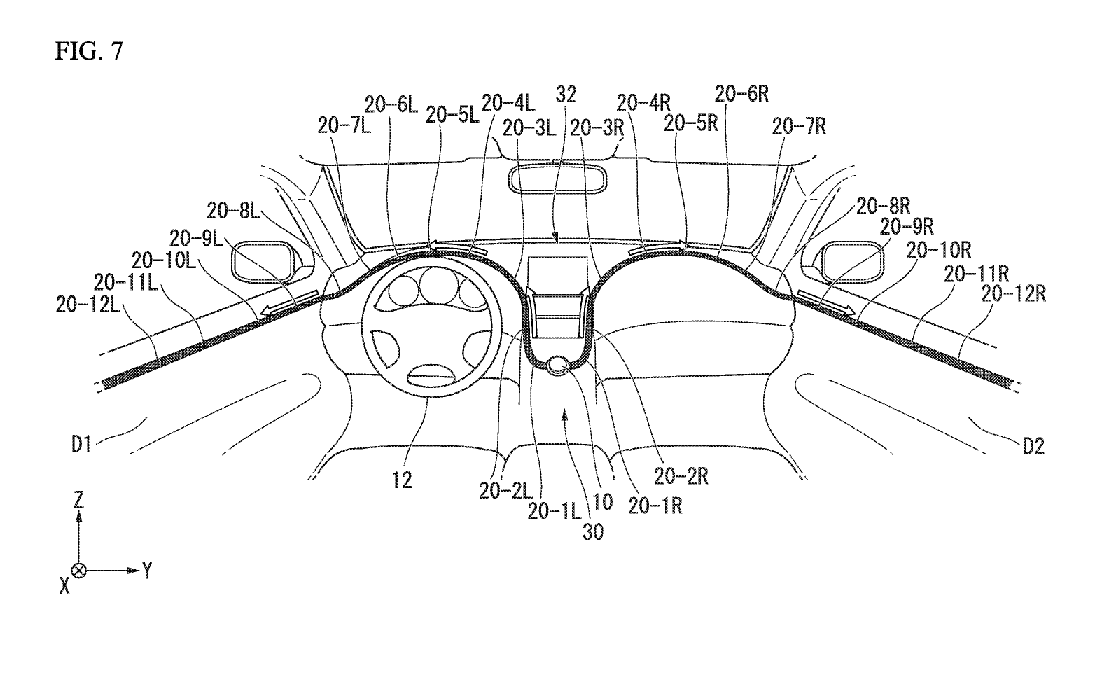

FIG. 7 is a view showing an appearance in which the light sources 20 are turned on in the order of arrangement by the control of the light source control unit 60. The light source control unit 60 performs a control in which, for example, when the light source control unit 60 receives a signal indicating that the start switch 10 is switched from an OFF state to an ON state, the light source 20-1 close to the start switch 10 to the light source 20-2, the light source 20-3, . . . , the light source 22-1, . . . , and the light source 22-4 along the curved line are sequentially turned on.

In this way, when the user operates the start switch 10 in order to start the vehicle M, the light sources 20 arranged in the vehicle M are turned on in the order of arrangement. Thereby, it is possible to achieve a dramatic effect that causes the user to feel a sense such that the vehicle M is gradually starting from the start switch 10 as an origin. As a result, it is possible to provide a dramatic effect that improves the affinity between the vehicle M and the user.

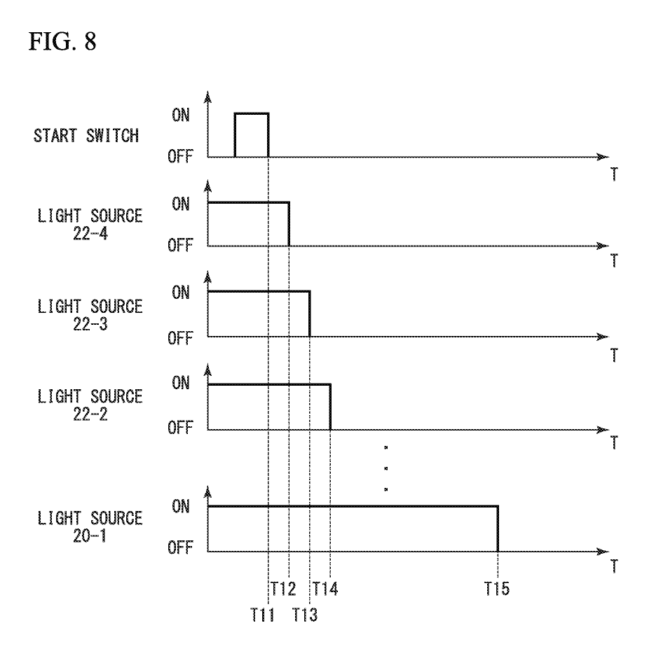

FIG. 8 is a timing chart showing an example of a temporal change in the states of the start switch 10 and the light sources 20 when the light sources are turned off. The present timing chart is an example of a case in which the user stops the engine of the vehicle M in a state where the engine of the vehicle M is running and the light sources 20 are lit.

When the start switch 10 is operated to be an OFF state at a time T11, the light source control unit 60 acquires an OFF signal output by the start switch 10. At a time T12, the light source control unit 60 controls the light source 22-4 that is the farthest from the start switch 10 to be an OFF state. Thereby, the light source 22-4 is turned off.

At a time T13, the light source control unit 60 controls the light source 22-3 to be an OFF state, and at a time T14, the light source control unit 60 controls the light source 22-2 to be an OFF state. Then, similarly, the light source control unit 60 controls the light source 20-12 to be an OFF state, . . . , and at a time T15, the light source control unit 60 controls the light source 20-1 to be an OFF state. Thereby, the plurality of light sources 20 are turned off from the light source 22-4 far from the start switch 10 toward the light source 20-1 close to the start switch 10. A speed at which the plurality of light sources 20 are turned off in the order of arrangement may be constant or may be variable.

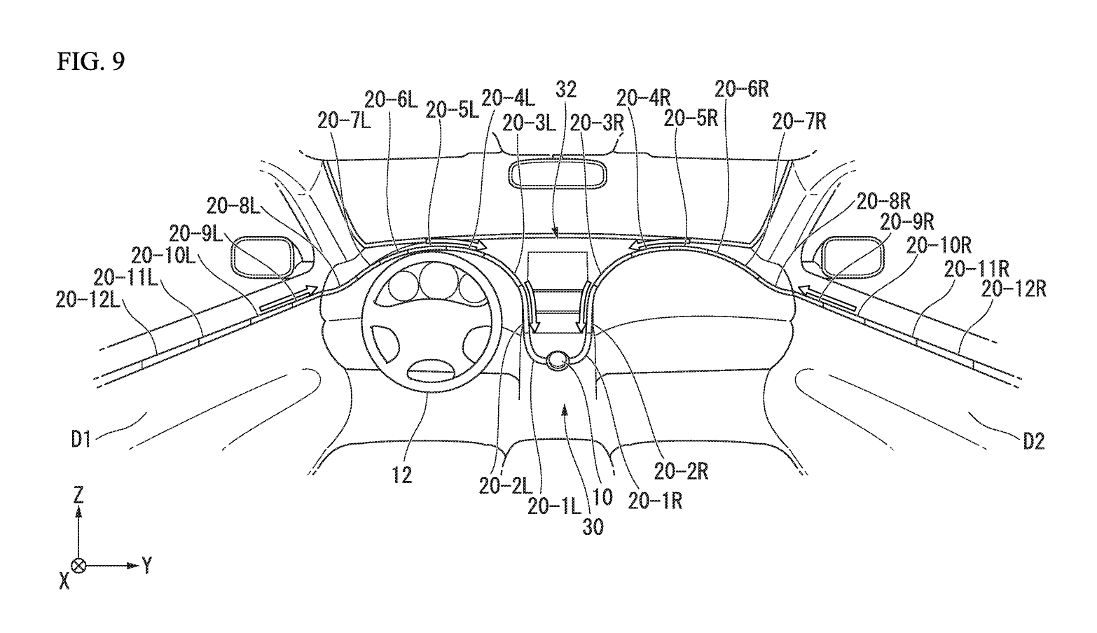

FIG. 9 is a view showing an appearance in which the light sources 20 are turned off in the order of arrangement by the control of the light source control unit 60. The light source control unit 60 performs a control in which, for example, when the light source control unit 60 receives a signal indicating an OFF state of the start switch 10, the light source 22-4 far from the start switch 10 to the light source 22-3, the light source 22-2, . . . , the light source 20-12, . . . , and the light source 20-1 along the curved line are sequentially turned off.

In this way, when the user operates the start switch 10 in order to stop the engine of the vehicle M, the light sources 20 arranged in the vehicle M are turned off sequentially in the order of arrangement. Thereby, it is possible to achieve a dramatic effect that causes the user to feel a sense such that the vehicle M is gradually stopping. As a result, it is possible to provide a dramatic effect that improves the affinity between the vehicle M and the user.

The vehicle illumination apparatus 1 of the first embodiment described above includes a plurality of light sources arranged on a curved line that extends in a direction or in a plurality of directions from the start switch 10 as an origin and turns on, when receiving a signal indicating that the start switch 10 is operated from an OFF state to an ON state, the plurality of light sources 20 from the start switch 10 as an origin, in the order of a light source 20 close to the start switch 10 to a light source 20 far from the origin. Further, the vehicle illumination apparatus 1 turns off, when receiving a signal indicating that the start switch 10 is operated from an ON state to an OFF state, the lit plurality of light sources 20 sequentially from the light source 20 far from the start switch 10 toward the light source 20 close to the start switch 10 in the order of arrangement of the plurality of light sources 20 arranged along the curved line. As a result, it is possible to provide a dramatic effect that improves the affinity between the vehicle M and the user.

### Second Embodiment

Hereinafter, a second embodiment is described. In the vehicle illumination apparatus 1 of the second embodiment, the speed at which the light sources 20 are turned on or are turned off is in accordance with the a turn-on speed or a turn-off speed of the light sources (illumination part) included in the in-vehicle devices provided on the vehicle M. Hereinafter, differences between the vehicle illumination apparatus 1 of the first embodiment and the vehicle illumination apparatus 1 of the second embodiment are mainly described.

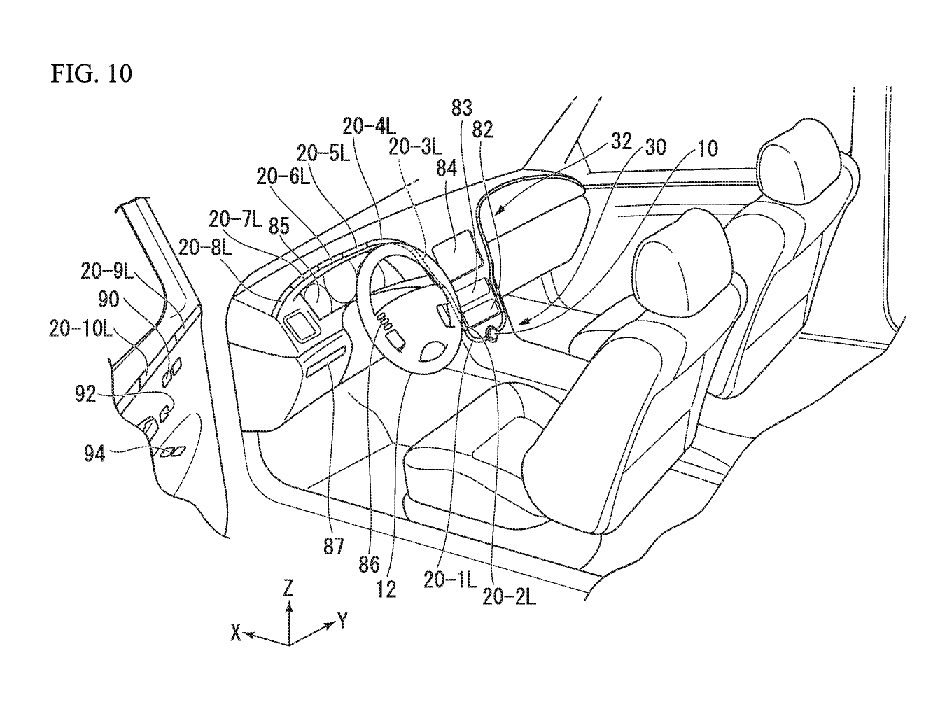

FIG. 10 is a view showing an example of the arrangement of in-vehicle devices provided on the vehicle M. For example, the start switch 10, an air conditioner panel 82, and an audio panel 83 are arranged in this order from the lower direction of the vehicle interior on the instrument panel 32 above the center console 30 of the vehicle M. A navigation display unit 84 is arranged on the instrument panel 32 at an upper part of the audio panel 83. A meter 85 is arranged at the instrument panel 32 on the driver seat side. A steering switch 86 is arranged on the steering device arranged at the driver seat. A visor monitor switch 87 is arranged below the instrument panel 32 on the left and lower (−YZ) side of the steering device. A seat memory 90, a vehicle interior handle illumination 92, and a power window switch 94 are arranged on the front left door D1. Examples of the in-vehicle devices include the air conditioner panel 82, the audio panel 83, the navigation display unit 84, the meter 85, the steering switch 86, the visor monitor switch 87, the seat memory 90, the vehicle interior handle illumination 92, and the power window switch 94. Hereinafter, when the above-described in-vehicle devices are not distinguished, the in-vehicle devices are simply referred to as an in-vehicle device 100.

The in-vehicle device 100 is controlled to an operation state or a stop state, for example, by the ECU 70. Each of the in-vehicle devices 100 has one or more light sources, and the light source is turned on or is turned off by the control of the ECU 70. For example, the light source included in the in-vehicle device 100 is turned on corresponding to the turn-on of the light source 20. For example, the light source included in the in-vehicle device 100 is turned off corresponding to the turn-off of the light source 20. In this case, the storage unit 50 stores identification information of a light source 20 that operates corresponding to a turn-on or turn-off timing of the in-vehicle device 100. The ECU 70 extracts, at a timing when the light sources 20 are turned on or turned off, an in-vehicle device 100 of which the light source is to be turned on based on information stored in the storage unit 50 and turns on the light source of the extracted in-vehicle device 100. The ECU 70 may start or stop the in-vehicle device 100 in accordance with the timing when the light sources 20 are turned on.

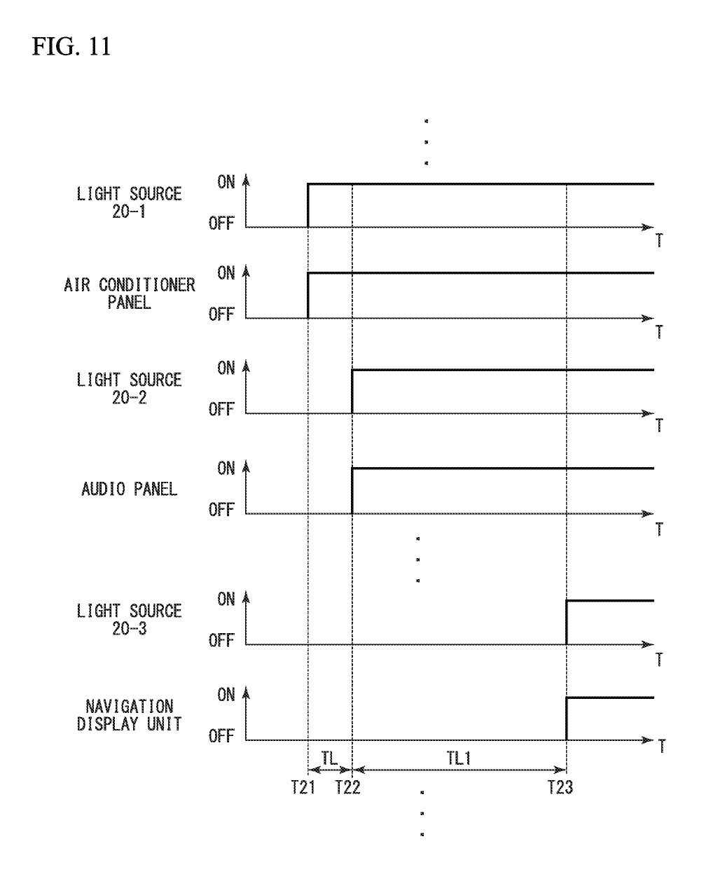

FIG. 11 is a timing chart showing an example of a temporal change in the states of the light sources 20 and the in-vehicle devices 100. The storage unit 50 stores an information table indicating a correspondence relationship between the timing when the light source 20 is turned on and an in-vehicle device 100 of which the light source is to be turned on in accordance with the timing when the light source 20 is turned on.

At a time T21 when the light source 20-1 is turned on, the ECU 70 turns on the light source of the air conditioner panel 82. Thereby, the light source 20-1 and the light source of the air conditioner panel 82 are simultaneously turned on. At a time T22 when the light source 20-2 is turned on, the ECU 70 turns on the light source of the audio panel 83. Thereby, the light source 20-2 and the light source of the audio panel 83 are simultaneously turned on. The time T22 is a time after a period of time elapses until the light source is turned on from when the air conditioner panel 82 receives a turn-on command by the ECU 70 at the time T21.

At a time T23 when the light source 20-3 is turned on, the ECU 70 turns on the light source of the navigation display unit 84. Thereby, the light source 20-3 and the light source of the navigation display unit 84 are simultaneously turned on. The time T23 is a time after a period of time elapses until the light source is turned on from when the audio panel 83 receives a turn-on command by the ECU 70 at the time T22.

For example, a period of time from when one light source 20 is turned on until the next light source 20 is turned on is set corresponding to the in-vehicle device 100 of which the light source is turned on in accordance with the one light source 20. For example, when a time required for the light source of the audio panel 83 to be turned on is longer than a time for the light sources of other in-vehicle devices 100 to be turned on, the turn-on timing of the light source 20-3 that is turned on after the audio panel 83 is turned on and the turn-on timing of the navigation display unit 84 that is turned on simultaneously with the light source 20-3 become late. As shown in the drawing, a period of time TL1 from the time T22 to the time T23 is set to be longer than a period of time TL from the time T21 to the time T22.

Thereby, the vehicle illumination apparatus 1 can synchronize the turn-on timings of the in-vehicle devices 100 with the turn-on timings of the light sources 20.

After the time T23, the ECU 70 turns on the meter 85 in accordance with the timing when the light source 20-4 is turned on. The ECU 70 turns on the steering switch 86 in accordance with the timing when the light source 20-6 is turned on. The ECU 70 turns on the visor monitor switch 87 in accordance with the timing when the light source 20-8 is turned on. The ECU 70 turns on the seat memory 90 in accordance with the timing when the light source 20-9 is turned on. The ECU 70 turns on the vehicle interior handle illumination 92 and the power window switch 94 in accordance with the timing when the light source 20-10 is turned on.

In this way, when the plurality of light sources 20 are sequentially turned on, the vehicle illumination apparatus 1 turns on the light source (illumination part) of the one or more in-vehicle devices 100 in accordance with the turn-on of the plurality of light sources 20. As a result, it is possible to provide a dramatic effect such that the affinity between the vehicle M and the user is further improved. Further, the vehicle illumination apparatus 1 can make the start of the in-vehicle device 100 be recognizable to the user.

When the ECU 70 receives a signal indicating an OFF state from the start switch 10, the ECU 70 controls the in-vehicle devices 100 to sequentially start the turn-off of the light sources of the in-vehicle devices 100 in association with the light sources 20 that are turned off from the light source 20 far from the start switch 10 to the light source 20 close to the start switch 10. The ECU 70 turns off the light source of the handle illumination 34L or 34R provided on the rear door in accordance with the turn-off of the light sources 20 arranged on the rear door. The ECU 70 turns off the vehicle interior handle illumination 92 and the power window switch 94 in accordance with the timing when the light source 20-10 is turned off. Then, similarly, the ECU 70 turns off the in-vehicle device 100 at a timing when the light sources 20 are turned off in an order that is opposite to the order in which the light sources 20 and the in-vehicle devices 100 are turned on. When the plurality of light sources 20 are sequentially turned off, the vehicle illumination apparatus 1 turns off the light source (illumination part) of the one or more in-vehicle devices 100 in accordance with the turn-off of the plurality of light sources 20. As a result, it is possible to provide a dramatic effect such that the affinity between the vehicle M and the user is further improved. Further, the vehicle illumination apparatus 1 can make the stop of the in-vehicle device 100 be recognizable to the user.

The vehicle illumination apparatus 1 of the second embodiment described above turns on, when the plurality of light sources 20 are sequentially turned on, the light source (illumination part) of the one or more in-vehicle devices 100 in accordance with the turn-on of the plurality of light sources 20, and therefore, it is possible to make the start of the in-vehicle device 100 be recognizable to the user. Further, the vehicle illumination apparatus 1 turns off, when the plurality of light sources 20 are sequentially turned off, the light source (illumination part) of the one or more in-vehicle devices 100 in accordance with the turn-off of the plurality of light sources 20, and therefore, it is possible to make the stop of the in-vehicle device 100 be recognizable to the user.

### Third Embodiment

Hereinafter, a third embodiment is described. In the vehicle illumination apparatus 1 of the third embodiment, a speed at which some light sources 20 that are provided on the instrument panel 32 and that are part of a plurality of light sources 20 are turned on or turned off is lower than a speed at which light sources 20 that are arranged on a vehicle interior sidewall of the vehicle M and a door are turned on or turned off. Hereinafter, the details are described.

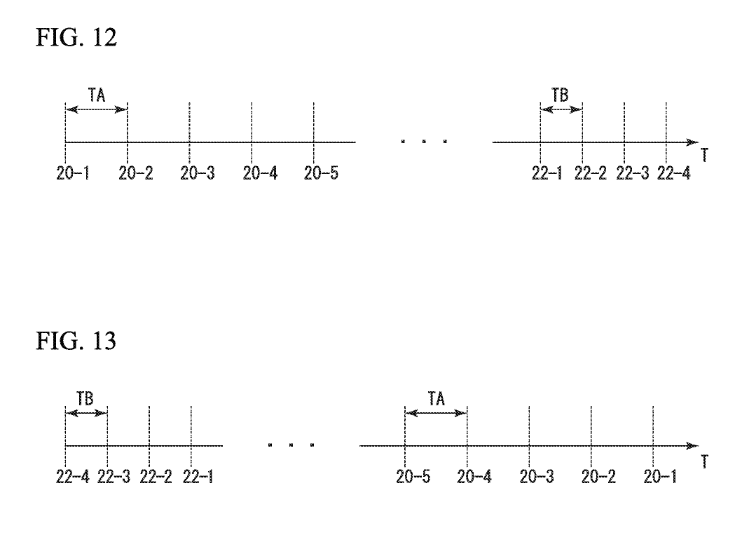

FIG. 12 is a view showing a turn-on speed of the light sources 20 arranged on the instrument panel 32 and the light sources 20 arranged on a vehicle interior sidewall and a door. The horizontal axis represents time. The reference numeral on the horizontal axis indicates the timing when the light source 20 is turned on. For example, the light source control unit 60 controls the light sources 20-1 to 20-8 arranged on the instrument panel 32 so as to be turned on in the order of arrangement at a time interval TA. On the other hand, the light source control unit 60 controls the light sources 20-9 to 20-12 and the light sources 22-1 to 22-4 arranged on the vehicle interior sidewall of the vehicle M and the door so as to be turned on in the order of arrangement at a time interval TB which is shorter than the time interval TA. Thereby, the light sources 20 arranged on the instrument panel 32 are turned on slowly compared to the light sources 20 arranged on the vehicle interior sidewall and the door.

The time interval TA is set, for example, based on a shift time from when a command signal is given to the in-vehicle device 100 arranged on the instrument panel 32 until the light source of the in-vehicle device 100 emits light. The shift time is a period of time from when a command signal is given to the in-vehicle device 100 until the light source of the in-vehicle device 100 is turned on. For example, the time interval TA is set to the longest shift time of the shift times of the in-vehicle devices 100. The time interval TA may be changed at each one of the timings when the light sources 20-1 to 20-8 are turned on. In this case, the shortest time interval TA of the changed time intervals TA may be longer than the time interval TB.

FIG. 13 is a view showing a turn-off speed of the light sources 20 arranged on the instrument panel 32 and the light sources 20 arranged on the vehicle interior sidewall and the door. The horizontal axis represents time. The reference numeral on the horizontal axis indicates the timing when the light source 20 is turned off. The light source control unit 60 turns off the light sources 20-9 to 20-12 and the light sources 22-1 to 22-4 arranged on the vehicle interior sidewall of the vehicle M and the door in the order of arrangement at the time interval TB which is shorter than the time interval TA. The light source control unit 60 turns off the light sources 20-1 to 20-8 arranged on the instrument panel 32 in the order of arrangement, for example, at the time interval TA. Thereby, the light sources 20 arranged on the instrument panel 32 are turned off slowly compared to the light sources 20 arranged on the vehicle interior sidewall and the door. The time interval TA may be changed at each one of the timings when the light sources 20-1 to 20-8 are turned off. In this case, the shortest time interval TA of the changed time intervals TA may be longer than the time interval TB.

The vehicle illumination apparatus 1 of the third embodiment described above changes the turn-on or turn-off speed of the light sources 20 depending on the position where the light source 20 is arranged and thereby can achieve a dramatic effect in the vehicle interior to improve the affinity between the vehicle M and the user. For example, when the light sources 20 are turned on, the vehicle illumination apparatus can provide the user with a feeling of actively starting the vehicle. For example, when the light sources 20 are turned off, the vehicle illumination apparatus can provide the user with a feeling of actively stopping the vehicle.

### Fourth Embodiment

Hereinafter, a fourth embodiment is described. In the vehicle illumination apparatus 1 of the fourth embodiment, the light source control unit 60 changes the luminance of the light source 20. Hereinafter, the details are described.

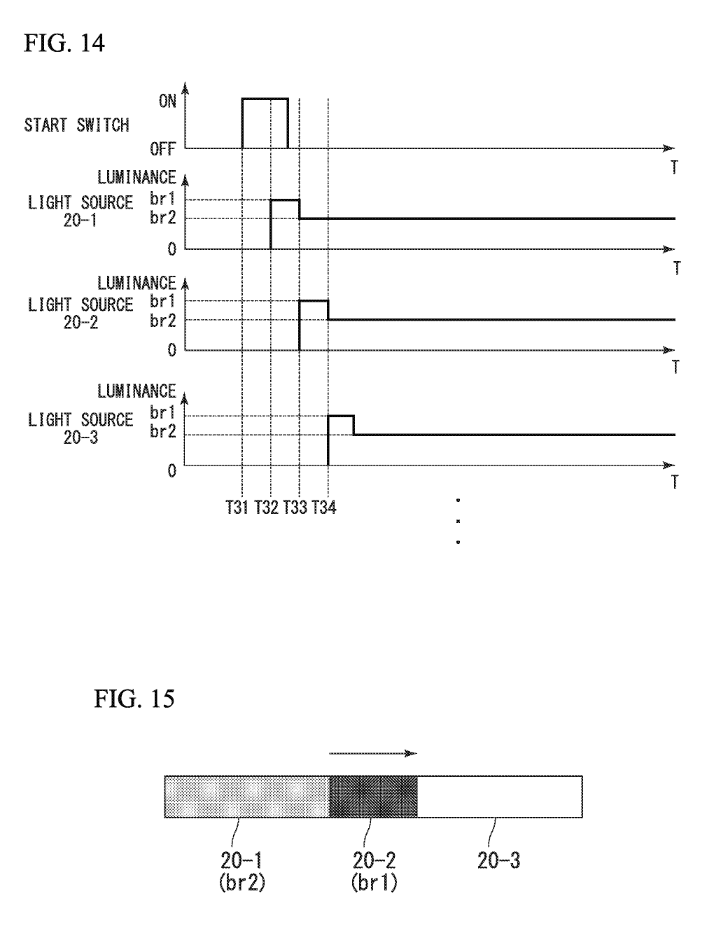

FIG. 14 is a timing chart showing an example of a temporal change in the states of the start switch 10 and the light sources 20 of the fourth embodiment. When the start switch 10 is made to an ON state at a time T31, the light source control unit 60 acquires an ON signal output by the start switch 10. At a time T32, the light source control unit 60 controls the light source 20-1 so as to be lit at a first luminance br1. Thereby, the light source 20-1 is lit at the first luminance br1.

At a time T33, the light source control unit 60 controls the light source 20-1 at the first luminance br1 to a second luminance br2 which is a somewhat lower luminance than the first luminance br1. Further, the light source control unit 60 controls the light source 20-2 so as to be lit at the first luminance br1. At a time T34, the light source control unit 60 controls the light source 20-2 at the first luminance br1 to the second luminance br2. Further, the light source control unit 60 controls the light source 20-3 so as to be lit at the first luminance br1. Then, similarly, the light source control unit 60 controls the luminance of the light source 20.

FIG. 15 is a view showing an appearance in which the luminance of the light sources 20 is changed when the light sources are turned on. The light source control unit 60 controls the light source 20-2 as a turn-on target to be lit at the first luminance br1 and controls the light source 20-1 to be lit at the second luminance. The light source 20-1 is a light source which has been turned on before the light source 20-2 is turned on. In this way, the light source control unit 60 controls the light source 20 as a turn-on target to be lit at the first luminance br1 and controls the luminance of the light source 20, which has been turned on before the light source 20 as a turn-on target is turned on, to the second luminance br2, and thereby, it is possible to achieve a dramatic effect in which a light source 20 at the first luminance flows in the vehicle interior like a shooting star.

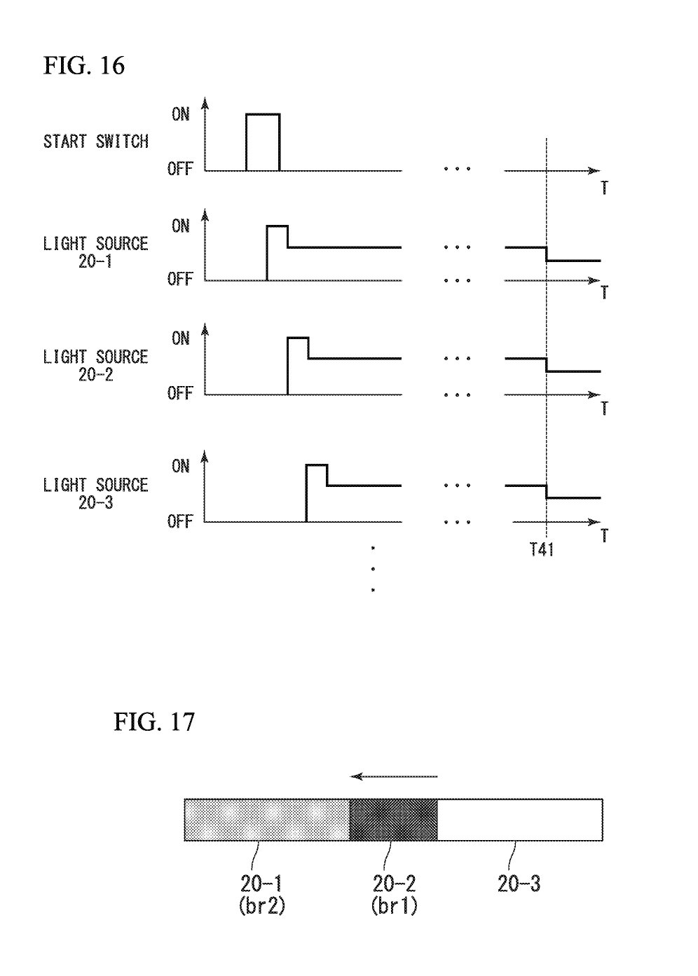

When all the light sources 20 are turned on, the light source control unit 60 may control the light sources 20 such that the luminance of the light sources 20 that have been turned on becomes a third luminance br3 which is a somewhat lower luminance than the second luminance br2. FIG. 16 is a view showing a timing chart when the light sources 20 are controlled to the third luminance br3. At a time T41 when all the light sources are controlled to a turned-on state from a turned-off state, the light source control unit 60 controls the light sources 20 such that the light sources 20 which have been lit at the second luminance br2 are lit at the third luminance br3. Thereby, after all the light sources 20 are turned on, it is possible to make the vehicle interior of the vehicle M be a relaxed atmosphere.

When the light sources 20 are turned off in the order of arrangement, the light source control unit 60 may change the luminance of the light source 20. In this case, the light source control unit 60 controls the luminance of the light source 20 that is to be turned off to the first luminance br1 that is the brightest and controls the luminance of another lit light source 20 to the second luminance br2. FIG. 17 is a view showing an appearance in which the luminance of the light sources 20 is changed when the light sources are turned off. The light source control unit 60 controls the luminance of the light source 20 as a turn-off target to the first luminance br1 and controls the luminance of another lit light source 20 to the second luminance br2 to thereby achieve a dramatic effect in which the light source 20 at the first luminance absorbs the light source 20 at the second luminance.

Since the vehicle illumination apparatus 1 of the fourth embodiment described above changes the luminance of the light output by the light source 20 depending on a scene, it is possible to achieve a dramatic effect in accordance with the scene, and it is possible to provide a dramatic effect that further improves the affinity between the vehicle M and the user.

The above embodiments are described using an example in which the vehicle illumination apparatus 1 turns on the light sources 20-1 to 20-12 in this order; however, for example, the turn-on order of the light sources 20 may be partially interchanged. The light sources may be turned on in the order of the light sources 20-2, 20-1, 20-3, and 20-4 or may be turned on in the order of the light sources 20-1, 20-2, 20-4, and 20-3. Further, for example, the turn-off order of the light sources 20 may be partially interchanged. The light sources may be turned off in the order of the light sources 22-3, 22-4, 22-2, and 22-1 or may be turned off in the order of the light sources 22-4, 22-2, 22-3, and 22-1.

The above embodiments are described using an example in which the processes of the first embodiment to the fourth embodiment are different embodiments; however, a process in which the processes of the embodiment are appropriately combined may be performed. For example, the processes of the second embodiment to the fourth embodiment may be combined; the light sources of the in-vehicle devices 100 may be turned on in accordance with the turn-on or turn-off of the light sources 20, the light sources 20 arranged on the instrument panel 32 may be turned on slowly compared to the light sources 20 arranged on the vehicle interior sidewall and the like, and when all the light sources 20 are lit after the light source 20 are turned on to be lit at the first luminance and at the second luminance, the light sources 20 are lit at the third luminance.

Although embodiments of the invention have been described referring to the drawings, the invention is not limited to the embodiments, and various modifications and replacements can be added to the embodiments without departing from the scope of the invention.

What is claimed is:

1. A vehicle illumination apparatus, comprising:
a start switch that is provided in a vehicle interior, is operated by a vehicle user, and is used to start a vehicle system;
a plurality of light sources arranged on a curved line that extends in a direction or in a plurality of directions from the start switch as an origin; and
a control unit that turns on, when receiving a first signal indicating that the start switch is operated from an OFF state to an ON state, the plurality of light sources from the operated start switch as an origin, in the order of a light source close to the origin to a light source far from the origin of the plurality of light sources along the curved line.

2. The vehicle illumination apparatus according to claim 1, wherein
the plurality of light sources are arranged along a ridged line included in a vehicle member in the vehicle interior.

3. The vehicle illumination apparatus according to claim 1, wherein
the plurality of light sources include light sources arranged on a front vehicle member in the vehicle interior continuously in a vertical direction and light sources arranged on the front vehicle member in the vehicle interior continuously in a horizontal direction, wherein
the control unit turns on the light sources arranged continuously in the vertical direction first and then turns on the light sources arranged continuously in the horizontal direction.

4. The vehicle illumination apparatus according to claim 1, wherein
the control unit turns off, when receiving a second signal indicating that the start switch is operated from an ON state to an OFF state, the lit plurality of light sources in the order of the light source far from the origin to the light source close to the origin of the plurality of light sources along the curved line.

5. The vehicle illumination apparatus according to claim 1, further comprising
one or more in-vehicle devices provided in the vehicle and each having an illumination part, wherein
the control unit turns on, when the plurality of light sources are sequentially turned on, the illumination part of the one or more in-vehicle devices in accordance with the turn-on of the plurality of light sources.

6. The vehicle illumination apparatus according to claim 5, wherein
the control unit turns off, when the plurality of light sources are sequentially turned off, the illumination part of the one or more in-vehicle devices in accordance with the turn-off of the plurality of light sources.

7. The vehicle illumination apparatus according to claim 1, wherein
part of the plurality of light sources is provided on an instrument panel of the vehicle, and
the control unit controls a speed at which light sources that are provided on the instrument panel of the plurality of light sources are sequentially turned on to be lower than a speed at which light sources that are not provided on the instrument panel of the plurality of light sources are sequentially turned on.

8. The vehicle illumination apparatus according to claim 7, wherein
the control unit controls a speed at which the light sources that are provided on the instrument panel of the plurality of light sources are sequentially turned off to be lower than a speed at which the light sources that are not provided on the instrument panel of the plurality of light sources are sequentially turned off.
